(19) United States
(12) Patent Application Publication
(10) Pub. No.: US 2018/0157667 A1
(43) Pub. Date: Jun. 7, 2018

(54) SYSTEM AND METHOD FOR GENERATING A THEME FOR MULTIMEDIA CONTENT ELEMENTS

(71) Applicant: Cortica, Ltd., TEL AVIV (IL)

(72) Inventors: Igal RAICHELGAUZ, Tel Aviv (IL); Karina ODINAEV, Tel Aviv (IL); Yehoshua Y ZEEVI, Haifa (IL)

(73) Assignee: Cortica, Ltd., TEL AVIV (IL)

(21) Appl. No.: 15/810,532

(22) Filed: Nov. 13, 2017

Related U.S. Application Data
(63) Continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/421,595, filed on Nov. 14, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04N 21/81; H04N 21/466; H04N 21/2668; H04N 21/258; H04N 7/173; H04H 20/10; H04H 60/66; H04H 60/56; H04H 60/46; H04H 60/37; H04H 20/26; H04L 29/08

(52) U.S. Cl. CPC G06F 17/30056; H04N 21/8106; H04N 21/466; H04N 21/2668; H04N 21/25891; H04N 7/17318; H04L 67/10; H04H 60/66; H04H 60/56; H04H 60/46; H04H 60/37; H04H 20/26; H04H 20/103

(57) ABSTRACT

A system and method for generating a theme for multimedia content elements (MMCEs), including analyzing a plurality of MMCEs, where the analyzing further includes generating at least one signature to each MMCE; identifying, based on the generated signatures, a plurality of concepts for each MMCE, wherein each concept is a collection of signatures and metadata describing the concept; determining, based on the identified concepts, at least one context of each MMCE; and generating, based on the determined contexts, a theme, wherein the theme is a cluster of contextually related MMCEs.

### CROSS-REFERENCE TO RELATED APPLICATIONS

This application claims the benefit of U.S. Provisional Application No. 62/421,595 filed on Nov. 14, 2016. This application is also a continuation-in-part of U.S. patent application Ser. No. 13/770,603 filed on Feb. 19, 2013, now pending, which is a continuation-in-part (CIP) of U.S. patent application Ser. No. 13/624,397 filed on Sep. 21, 2012, now U.S. Pat. No. 9,191,626. The Ser. No. 13/624,397 Application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Au. 21, 2007, and which is also a continuation-in-part of the below-referenced U.S. patent application Ser. No. 12/084,150; and,

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to the clustering of multimedia content elements, and more specifically to clustering of contextually related multimedia content elements.

### BACKGROUND

Since the advent of digital photography and, in particular, after the rise of social networks, the Internet has become inundated with uploaded images, videos, and other content. Searching for multimedia content can be difficult, as textual queries often do not result in retrieving desired content.

In an effort to address the problem, some users manually tag multimedia content in order to label the subject matter of the content to assist users seeking content featured in the multimedia files. The tags may be textual tags or other identifiers included in metadata of the multimedia content, thereby associating the tags with the multimedia content. Users may subsequently search for multimedia content elements based on tags by providing queries indicating a desired subject matter. Tags therefore make it easier for users to find content related to a particular topic or theme.

A popular textual tag is the hashtag. A hashtag is a type of label typically used on social networking websites, chats, forums, microblogging services, and the like. Users create and use hashtags by placing the hash character (or number sign) # in front of a word or unspaced phrase, either within the main text of a message associated with content, at the beginning, or at the end. Searching for the hashtag will then present each message and, consequently, each multimedia content element, that has been tagged with it.

Accurate and complete listings of hashtags can significantly increase exposure of users to certain multimedia content. Existing solutions for tagging typically rely on user inputs to provide identifications of subject matter. However, such manual solutions may result in inaccurate or incomplete tagging. Further, although some automatic tagging solutions exist, such solutions face challenges in efficiently and accurately identifying subject matter of multimedia content. Moreover, such solutions typically only recognize superficial expressions of subject matter in multimedia content and, therefore, fail to account for context in tagging multimedia content. Additionally, some websites limit the tagging capabilities of multimedia content, for example, by only allowing the tagging of people, but not object or locations, shown in an image. Accordingly, grouping images solely based on tags may not result in accurately grouping all related content.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for generating a theme for multimedia content elements (MMCEs). The method comprises: analyzing a plurality of MMCEs, where the analyzing further includes generating at least one signature to each MMCE; identifying, based on the generated signatures, a plurality of concepts for each MMCE, wherein each concept is a collection of signatures and metadata describing the concept; determining, based on the identified concepts, at least one context of each MMCE; and generating, based on the determined at least one context, a theme, wherein the theme is a cluster of contextually related MMCEs.

Certain embodiments disclosed herein also include a non-transitory computer readable medium having stored thereon instructions for causing a processing circuitry to perform a process, the process comprising: analyzing a plurality of MMCEs, wherein the analyzing further includes generating at least one signature to each MMCE; identifying, based on the generated signatures, a plurality of concepts for each MMCE, wherein each concept is a collection of signatures and metadata describing the concept; determining, based on the identified concepts, at least one context of each MMCE; and generating, based on the determined at least one context, a theme, wherein the theme is a cluster of contextually related MMCEs.

Certain embodiments disclosed herein also include a system for generating a theme for multimedia content elements (MMCEs). The system comprises: a processing circuitry; and a memory, the memory containing instructions that, when executed by the processing circuitry, configure the system to: analyze a plurality of MMCEs, wherein the analyzing includes generating at least one signature to each MMCE; identify, based on the generated signatures, a plurality of concepts for each MMCE, wherein each concept is a collection of signatures and metadata describing the concept; determine, based on the identified concepts, at least one context of each MMCE; and generate, based on the determined at least one contexts, a theme, wherein the theme is a cluster of contextually related MMCEs.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram utilized to describe the various disclosed embodiments.

FIG. 2 is a diagram of a Deep Content Classification system for creating concepts according to an embodiment.

FIG. 3 is a block diagram depicting the basic flow of information in the signature generator system.

FIG. 4 is a diagram showing the flow of patches generation, response vector generation, and signature generation in a large-scale speech-to-text system.

FIG. 5 is a flowchart illustrating a method for generating themes from multimedia content elements according to an embodiment.

FIG. 6 is a flowchart illustrating a method of analyzing a multimedia content element according to an embodiment.

FIG. 7 a flowchart illustrating a method for expanding themes within a database according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating themes for multimedia content elements. Multimedia content elements (MMCEs) are analyzed. The analysis may include generating signatures, identifying concepts for the signatures, determining contexts of each MMCE, or a combination thereof. A contextual compatibility is determined between at least two of the MMCEs. Based on the determined contextual compatibility, a theme including a cluster of contextually compatible MMCEs is generated.

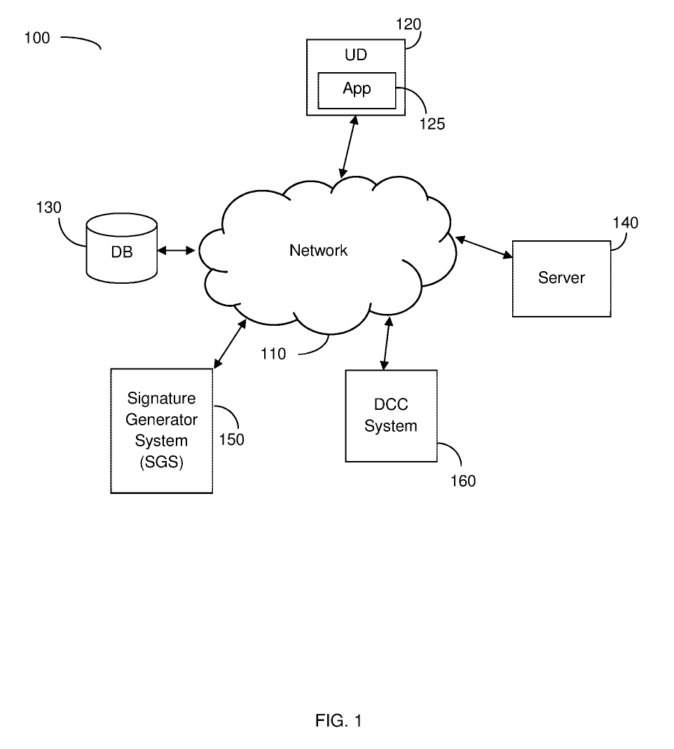

FIG. 1 is an example network diagram 100 utilized to describe the various disclosed embodiments. A user device 120, a database (DB) 130, a server 140, a signature generator system (SGS) 150, and a Deep Content Classification (DCC) system 160 are connected via a network 110. The network 110 may be, but is not limited to, a local area network (LAN), a wide area network (WAN), a metro area network (MAN), the world wide web (WWW), the Internet, a wired network, a wireless network, and the like, as well as any combination thereof.

The user device 120 may be, but is not limited to, a personal computer (PC), a personal digital assistant (PDA), a mobile phone, a smart phone, a tablet computer, a wearable computing device, and other kinds of wired and mobile devices capable of capturing, uploading, browsing, viewing, listening, filtering, and managing MMCEs as further discussed herein below. The user device 120 may have installed thereon an application 125 such as, but not limited to, a web browser. The application 125 may be downloaded from an application repository, such as the Apple® AppStore®, Google Play®, or any repositories hosting software applications. The application 125 may be pre-installed in the user device 120.

The application 125 may be configured to store and access MMCEs within the user device, such as on an internal storage (not shown), as well as to access MMCEs from an external source, such as the database 130 or a social media website, e.g., via the network 110. For example, the application 125 may be a web browser through which a user of the user device 120 accesses a social media website and uploads MMCEs thereto.

The database 130 is configured to store MMCEs, signatures generated based on MMCEs, concepts that have been generated based on signatures, contexts that have been generated based on concepts, themes, stories, or any combination thereof. The database 130 is accessible by the server 140, either via the network 110 (as shown in FIG. 1) or directly (not shown).

The server 140 may include a processing circuitry and a memory (both not shown). The processing circuitry may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

In an embodiment, the memory is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry, cause the processing circuitry to perform the various processes described herein. Specifically, the instructions, when executed, configure the processing circuitry to generate themes for MMCEs, as discussed further herein below.

In an embodiment, the server 140 is configured to receive or retrieve input MMCEs, for example from the user device 120 via the application 125 installed thereon, that are associated with a user of the user device 120. The MMCEs may be, but are not limited to, an image, a graphic, a video stream, a video clip, an audio stream, an audio clip, a video frame, a photograph, and so on, and any combinations or portions thereof. The MMCEs may be captured by a sensor (not shown) of the user device 120. The sensor may be, for example, a still camera, a video camera, a combination thereof, and the like. Alternatively, the MMCEs may be retrieved from a web source (not shown) over the network 110, such as a social media website, or from the database 130.

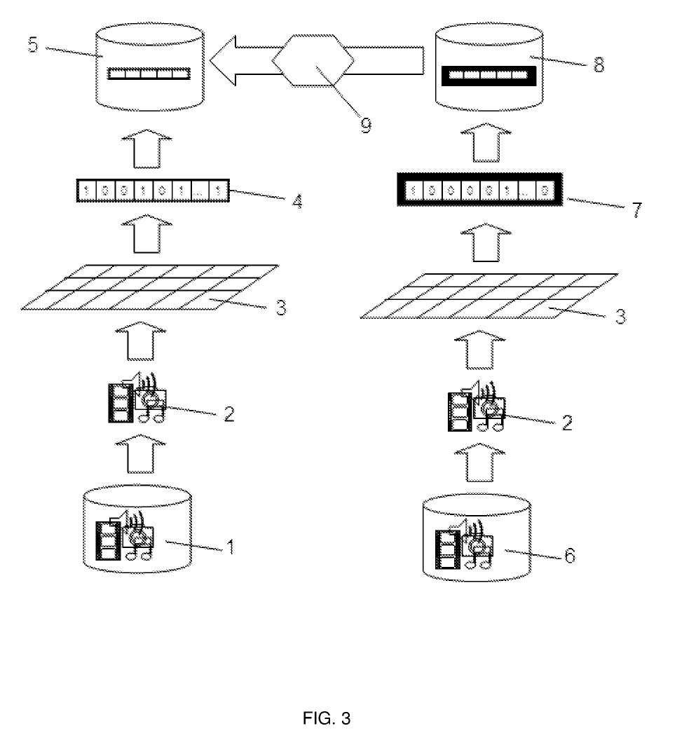

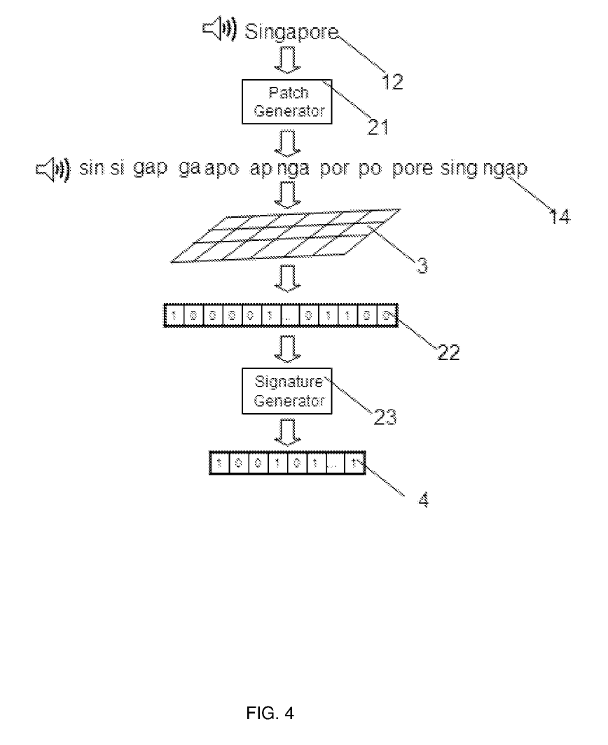

The server 140 is configured to analyze the MMCEs. The analysis includes generating signatures based on each of the MMCEs. To this end, in an embodiment, the server 140 may be configured to send the MMCEs to the SGS 150. The SGS 150 may be configured to generate at least one signature for each MMCE, based on content of the received MMCE as described further herein below with respect to FIGS. 3 and 4. The signatures may be robust to noise and distortion as discussed below.

In an embodiment, the server 140 may further be configured to identify metadata associated with each of the MMCEs. The metadata may include, for example, a time stamp of the capturing of the MMCE, the device used for the capturing, a location pointer, tags, comments, and the like.

The Deep Content Classification (DCC) system 160 is configured to identify at least one concept based on the generated signatures. Each concept is a collection of signatures representing MMCEs and metadata describing the concept. As a non-limiting example, a ‘Superman concept’ is a signature-reduced cluster of signatures describing elements (such as multimedia elements) related to, e.g., a Superman cartoon: a set of metadata representing proving textual representation of the Superman concept. As another example, metadata of a concept represented by the signature generated for a picture showing a bouquet of red roses is “flowers.” As yet another example, metadata of a concept represented by the signature generated for a picture showing a bouquet of wilted roses is “wilted flowers.”

In an embodiment, the server 140 is further configured to determine one or more contexts for the MMCEs. Each context is determined by correlating among signatures such as the generated signatures, signatures representing the identified concepts, or both. A strong context may be determined, e.g., when there are at least a threshold number of concepts that satisfy the same predefined condition. As a non-limiting example, by correlating a signature of a person in a baseball uniform with a signature of a baseball stadium, a context representing a “baseball player” may be determined. Correlations among the concepts of multimedia content elements can be achieved using probabilistic models by, e.g., identifying a ratio between signatures' sizes, a spatial location of each signature, and the like. Determining contexts for multimedia content elements is described further in the above-referenced U.S. patent application Ser. No. 13/770,603, assigned to the common assignee, which is hereby incorporated by reference. It should be noted that using signatures for determining the context ensures more accurate determination of context than, for example, when using metadata alone.

In an embodiment, based on the determined contexts, the server 140 is configured to determine a set of two or more contextually compatible MMCEs. The contextually related MMCEs may be MMCEs having contexts that match. The server 140 is further configured to cluster the set of two or more contextually compatible MMCEs to generate a theme, where the theme is the cluster of contextually compatible MMCEs.

In an embodiment, based on the generated theme and the metadata, the server 140 may be configured to generate a story, where a story is a subset of a theme that shares at least one common story parameter. Specifically, the story is at least a portion of the theme including a cluster of story MMCEs, where each story MMCE shares the at least one common story parameter. The story parameters may include, but are not limited to, a time of an MMCE capture, a date of an MMCE capture, a location depicted in an MMCE, one or more persons depicted in an MMCE, an emotion displayed in the MMCE (e.g., happiness, sadness, confusion), and the like.

As a non-limiting example, ten images each show a person swimming in Brighton Beach, N.Y. Accordingly, each image is determined to have a context representing “swimming in Brighton Beach.” The 10 images are determined to be contextually compatible, and are clustered together to generate the theme for “swimming in Brighton Beach.” When the 10 images include 4 images having a time stamp indicating “Apr. 1, 2016” and 6 images having a time stamp indicating “May 5, 2016,” the 4 images may be clustered to generate the story “swimming on Brighton Beach on Apr. 1, 2016,” and the 6 images may be clustered to generate the story “swimming on Brighton Beach on May 5, 2016.”

It should be noted that the generation of themes, stories, or both, may be adjusted based on personal variables associated with a user. Such variables may include, for example: themes previously generated by the user, demographic information, professional field, hobbies, residence, family status, and the like. In an embodiment, the adjustment may be based on the identification of patterns connected to a user. For example, if a user is associated with pictures of swimming in Brighton Beach on every summer weekend, it may not be necessary to generate a separate story of “swimming in Brighton Beach” for each cluster of images having a different time stamp.

The generated stories and themes may be sent for storage, for example, to the DB 130, a local memory storage unit of the user device 120, or both.

It should be noted that only one user device 120 and one application 125 are discussed with reference to FIG. 1 merely for the sake of simplicity. However, the embodiments disclosed herein are applicable to a plurality of user devices that can communicate with the server 140 via the network 110, where each user device includes at least one application.

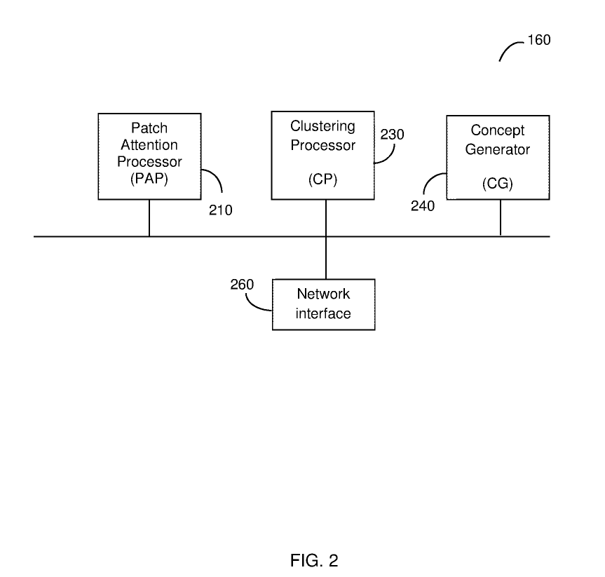

FIG. 2 shows a diagram of a DCC system 160 for creating concepts according to an embodiment. The DCC system 160 is configured to receive or retrieve MMCEs, for example from the server 140 via a network interface 260.

Each MMCE is processed by a patch attention processor (PAP) 210, resulting in a plurality of patches that are of specific interest, or otherwise of higher interest than other patches. A more general pattern extraction, such as an attention processor (AP) (not shown) may also be used in lieu of patches. The AP receives the MMCE that is partitioned into items; an item may be an extracted pattern or a patch, or any other applicable partition depending on the type of the MMCE. The functions of the PAP 210 are described herein below in more detail.

The patches that are of higher interest are then used by a signature generator, e.g., the SGS 150 of FIG. 1, to generate signatures based on the patch. A clustering processor (CP) 230 inter-matches the generated signatures once it determines that there are a number of patches that are above a predefined threshold. The threshold may be defined to be large enough to enable proper and meaningful clustering. With a plurality of clusters, a process of clustering reduction takes place so as to extract the most useful data about the cluster and keep it at an optimal size to produce meaningful results. The process of cluster reduction is continuous. When new signatures are provided after the initial phase of the operation of the CP 230, the new signatures may be immediately checked against the reduced clusters to save on the operation of the CP 230. A more detailed description of the operation of the CP 230 is provided herein below.

A concept generator (CG) 240 is configured to create concept structures (hereinafter referred to as concepts) from the reduced clusters provided by the CP 230. Each concept includes a plurality of metadata associated with the reduced clusters. The result is a compact representation of a concept that can now be easily compared against a MMCE to determine if the received MMCE matches a concept stored, for example, in the database 130 of FIG. 1. This can be done, for example and without limitation, by providing a query to the DCC system 160 for finding a match between a concept and a MMCE.

It should be appreciated that the DCC system 160 can generate a number of concepts significantly smaller than the number of MMCEs. For example, if one billion (10⁹) MMCEs need to be checked for a match against another one billon MMCEs, typically the result is that no less than 10⁹×10⁹=10¹⁸ matches have to take place. The DCC system 160 would typically have around 10 million concepts or less, and therefore at most only 2×10⁶×10⁹=2×10¹⁵ comparisons need to take place, a mere 0.2% of the number of matches that have had to be made by other solutions. As the number of concepts grows significantly slower than the number of MMCEs, the advantages of the DCC system 160 would be apparent to one with ordinary skill in the art.

It should be noted that the DCC system 160 is described with respect to generating signatures via a separate signature generator system, but that the DCC system 160 may include the signature generator system without departing from the scope of the disclosure.

FIGS. 3 and 4 illustrate the generation of signatures for the multimedia content elements by the SGS 150 according to an embodiment. An example high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment the server 130 is configured with a plurality of computational cores to perform matching between signatures.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 140 and SGS 150. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≤i≤L) may consist of a single leaky integrate-to-threshold unit (LTU) node or more nodes. The node nᵢ equations are:

$${V}_{i} = {\sum }_{j}^{ } {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thₓ is a constant Threshold value, where ‘x’ is ‘S’ for Signature and ‘RS’ for Robust Signature; and Vᵢ is a Coupling Node Value.

The Threshold values Thₓ are set differently for Signature generation and for Robust Signature generation. For example, for a certain distribution of Vᵢ values (for the set of nodes), the thresholds for Signature (Th_{S}) and Robust Signature (Th_{RS}) are set apart, after optimization, according to at least one or more of the following criteria:

1: For: Vᵢ>Th_{RS}

1−p(V>Th_{S})−1−(1−ϵ)^{l}<<1

i.e., given that l nodes (cores) constitute a Robust Signature of a certain image I, the probability that not all of these I nodes will belong to the Signature of same, but noisy image, l̅ is sufficiently low (according to a system's specified accuracy).

2:

p(Vᵢ>Th_{RS})≈l/L

i.e., approximately l out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. No. 8,326,775, assigned to the common assignee, which is hereby incorporated by reference.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the U.S. Pat. No. 8,655,801 referenced above, the contents of which are incorporated by reference.

Signatures are generated by the Signature Generator System based on patches received either from the PAP 210, or retrieved from the database 130, as discussed herein above. It should be noted that other ways for generating signatures may also be used for the purpose the DCC system 160. Furthermore, as noted above, the array of computational cores may be used by the PAP 210 for the purpose of determining if a patch has an entropy level that is of interest for signature generation according to the principles of the invention.

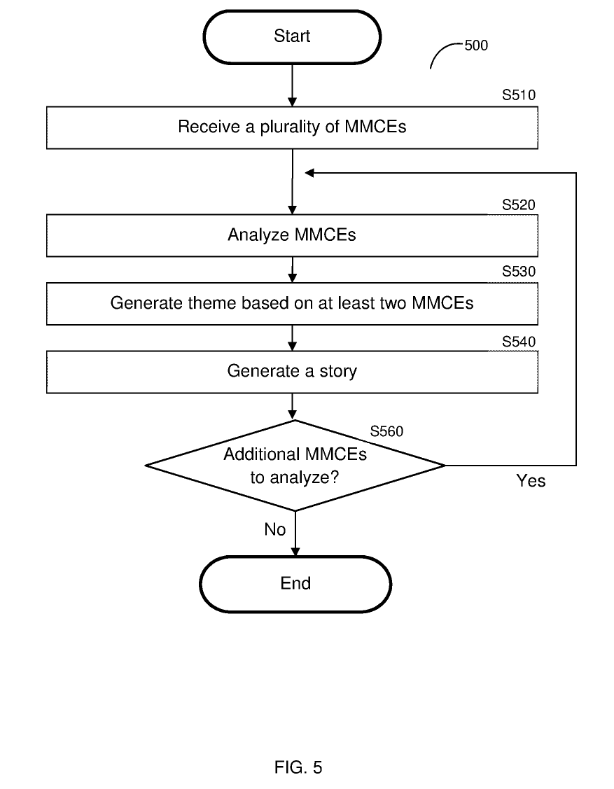

FIG. 5 is a flowchart illustrating a method 500 for generating themes from MMCEs according to an embodiment. In an embodiment, the method may be performed by the server 140, FIG. 1.

At S510, a plurality of MMCEs is received or retrieved. At S520, the plurality of MMCEs is analyzed. In an embodiment, the analysis includes determining a context of each MMCE. To this end, S520 may further include generating signatures, identifying concepts, or a combination thereof, based on the received plurality of MMCEs as further described herein. The analysis may include sending the MMCEs to a DCC system (e.g., the DCC system 160, FIG. 1).

At S530, a theme is generated based on the determined contexts. A theme includes a cluster of contextually compatible MMCEs having matching contexts. To this end, in an embodiment, S530 includes comparing each context of each MMCE to each context of each other MMCE to determine if any contexts match. The matching may be based on a predetermined threshold. MMCEs having matching concepts may be determined to be contextually compatible, and a cluster may be generated for each set of two or more contextually compatible MMCEs.

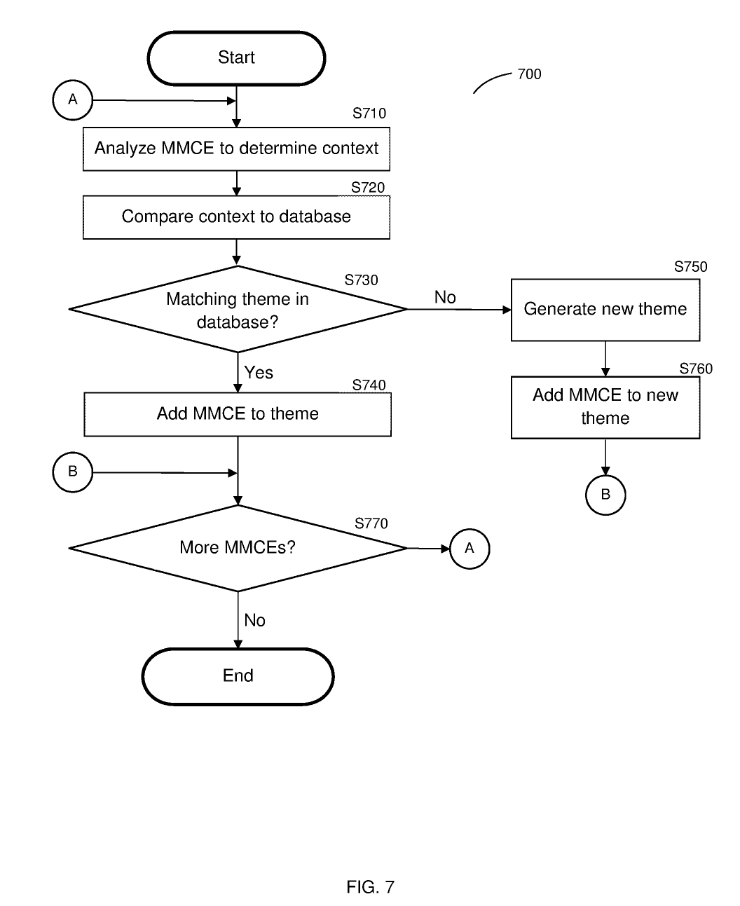

The theme may be stored in a database for subsequent use. In some implementations, the stored theme may further be associated with the matching context among MMCEs of the theme. Accordingly, contexts of a subsequently received MMCE may be compared to contexts associated with stored themes to determine whether a theme matches the MMCE, thereby allowing for expanding themes as described further herein below with respect to FIG. 7.

At optional S540, a story may be generated based on the generated theme, where the story is a sub-cluster of MMCEs of the theme having at least one story parameter in common. The story parameters may include, but are not limited to, a time of an MMCE capture, a date of an MMCE capture, a location depicted in an MMCE, one or more persons depicted in an MMCE, an emotion displayed in the MMCE, and the like. To this end, the generation may further be based on metadata of the MMCEs of the theme. A single theme may be utilized to generate multiple stories.

At S560, it is checked whether additional MMCEs are to be analyzed and if so, execution continues with S520; otherwise, execution terminates.

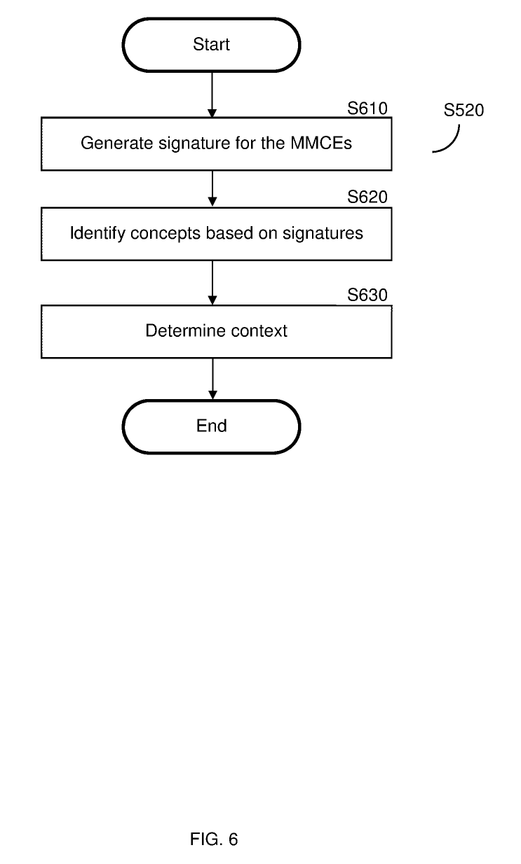

FIG. 6 is a flowchart illustrating a method S520 of analyzing an MMCE according to an embodiment. At S610, at least one signature is generated for the MMCE, where each signature represents at least a portion of the MMCE. The signatures may be robust to noise and distortion. The signatures may be generated by a signature generator system having a plurality of statistically independent computational cores, where the properties of each core are set independently of the properties of each other core.

At S620, at least one concept is identified based on the signatures, where a concept is a collection of signatures representing elements of the unstructured data and metadata describing the concept. The metadata may include, for example, a time stamp of the capturing of the MMCE, the device used for the capturing, a location pointer, tags or comments associated therewith, and the like. In an embodiment, S620 may include sending the generated signatures to a DCC system (e.g., the DCC system 160, FIG. 1), and receiving, from the DCC system, one or more matching concepts.

At S630, based on the concepts, a context is determined, where a context is a correlation between the determined concepts. In an embodiment, S630 includes correlating among signatures representing the determined concepts.

FIG. 7 is a flowchart illustrating a method 700 for expanding themes within a database according to an embodiment. At S710, at least one MMCE is analyzed to determine a context as explained herein above. At S720, the determined context is compared to previously determined contexts, e.g., contexts associated with themes stored in a database. In an embodiment, S720 includes comparing the determined context a matching context (e.g., a context common among all of the clustered MMCEs of the theme) associated with each theme. At S730, based on the comparison, it is determined if there is a matching theme within the database. For example, if at least one theme in the database is determined to be associated with a context that matches the context of the analyzed MMCE, a matching theme exists. If so, execution continues with S740, otherwise, execution continues with S750.

At S740, the analyzed MMCE is added to the matching theme, i.e., the analyzed MMCE is added to the cluster of MMCEs that have a common theme. Execution continues with S770.

At S750, if no matching theme exists in the database, a new matching theme is generated. At S760, the analyzed MMCE is added to the theme. In an embodiment, the new theme is stored in the database. Execution continues with S770.

At S770, it is checked whether additional MMCEs are to be analyzed, and if so, execution continues with S710; otherwise, execution terminates.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating a theme for multimedia content elements (MMCEs), comprising:
analyzing a plurality of MMCEs, wherein the analyzing further comprises generating at least one signature to each MMCE;
identifying, based on the generated signatures, a plurality of concepts for each MMCE, wherein each concept is a collection of signatures and metadata describing the concept;
determining, based on the identified concepts, at least one context of each MMCE; and
generating, based on the determined contexts, a theme, wherein the theme is a cluster of contextually related MMCEs.

2. The method of claim 1, wherein each context is determined by correlating among the plurality of concepts identified for one of the MMCEs.

3. The method of claim 1, wherein the contextually related MMCEs share a matching context.

4. The method of claim 1, further comprising:
generating, based on the theme, at least one story, wherein each story is a subset of the theme and includes a cluster of MMCEs that shares at least one common story parameter.

5. The method of claim 4, wherein the at least one common story parameter includes at least one of: a time, a date, a location, at least one person depicted in the MMCEs of the story, and an emotion displayed in the MMCEs of the story.

6. The method of claim 1, wherein the generation of the theme may be adjusted based on personal variables of a user.

7. The method of claim 6, wherein the personal variables include at least one of:
themes previously generated by the user, user demographic information, a professional field of the user, hobbies of the user, a residence of the user, a family status of the user, and patterns of the user.

8. The method of claim 1, wherein the at least one signature is robust to noise and distortion.

9. The method of claim 1, wherein each signature is generated by a signature generator system including a plurality of at least partially statistically independent computational cores, wherein the properties of each core are set independently of the properties of each other core.

10. A non-transitory computer readable medium having stored thereon instructions for causing a processing circuitry to perform a process, the process comprising:
analyzing a plurality of MMCEs, wherein the analyzing further comprises generating at least one signature to each MMCE;
identifying, based on the generated signatures, a plurality of concepts for each MMCE, wherein each concept is a collection of signatures and metadata describing the concept;
determining, based on the identified concepts, at least one context of each MMCE; and
generating, based on the determined contexts, a theme, wherein the theme is a cluster of contextually related MMCEs.

11. A system for generating a theme for multimedia content elements (MMCEs), comprising:
a processing circuitry; and
a memory, the memory containing instructions that, when executed by the processing circuitry, configure the system to:
analyze a plurality of MMCEs, wherein the analyzing further comprises generating at least one signature to each MMCE;
identify, based on the generated signatures, a plurality of concepts for each MMCE, wherein each concept is a collection of signatures and metadata describing the concept;
determine, based on the identified concepts, at least one context of each MMCE; and
generate, based on the determined contexts, a theme, wherein the theme is a cluster of contextually related MMCEs.

12. The system of claim 11, wherein each context is determined by correlating among the plurality of concepts identified for one of the MMCEs.

13. The system of claim 11, wherein the contextually related MMCEs share a matching context.

14. The system of claim 11, further comprising:
generate, based on the theme, at least one story, wherein each story is a subset of the theme and includes a cluster of MMCEs that shares at least one common story parameter.

15. The system of claim 14, wherein the at least one common story parameter includes at least one of: a time, a date, a location, at least one person depicted in the MMCEs of the story, and an emotion displayed in the MMCEs of the story.

16. The system of claim 11, wherein the generation of the theme may be adjusted based on personal variables of a user.

17. The system of claim 16, wherein the personal variables include at least one of:
themes previously generated by the user, user demographic information, a professional field of the user, hobbies of the user, a residence of the user, a family status of the user, and patterns of the user.

18. The system of claim 11, wherein the at least one signature is robust to noise and distortion.

19. The system of claim 11, wherein each signature is generated by a signature generator system including a plurality of at least partially statistically independent computational cores, wherein the properties of each core are set independently of the properties of each other core.
